(19) United States
(12) Patent Application Publication
(10) Pub. No.: US 2011/0178704 A1
(43) Pub. Date: Jul. 21, 2011

(54) NAVIGATION DEVICE CAPABLE OF ADDING PATH TO NAVIGATION PLAN INDEPENDENTLY

(75) Inventors: Hui-Ling Chan, Jung-Ho City (TW); Chih-Hsiang Chen, Jung-Ho City (TW); Yu-Hsin Chuo, Jung-Ho City (TW); Yao-Shih Leng, Jung-Ho City (TW)

(73) Assignee: MICRO-STAR INTERNATIONAL CO., LTD., Jung-Ho City (TW)

(21) Appl. No.: 12/330,291

(22) Filed: Dec. 8, 2008

(51) Int. Cl. G01C 21/34

(52) U.S. Cl. 701/209

(57) ABSTRACT

A navigation device capable of adding paths to a navigation plan independently is disclosed. The navigation device includes a global positioning module, a dynamic path-adding module, and a navigation module. The global positioning module receives road track coordinates signals of new paths to be created. The dynamic path-adding module creates new path data corresponding to the new paths in accordance with the road track coordinates signals of the new paths, determines added paths, and creates added path data corresponding to the added paths. The navigation module plans at least a navigation route in accordance with a map database, the new path data, and the added path data.

### FIELD OF THE INVENTION

The present invention relates to navigation devices, and more particularly, to a navigation device capable of creating new paths dynamically and adding the new paths to a navigation plan.

### BACKGROUND OF THE INVENTION

A conventional GPS navigation device features a travel track function whereby a new path is not only tracked and recorded but also displayed using the GPS coordinates of the new path and existing map-related data. However, a conventional GPS navigation device does not add the new path to a navigation plan, and in consequence the new path just serves as a reminder but is not added to a navigation route.

U.S. Pat. No. 5,948,043, entitled “Navigation System Using GPS Data”, disclosed a system for tracking an object (for example tracking an automobile as it moves over streets) using an electronic map and a GPS receiver. According to U.S. Pat. No. 5,948,043, based on the previous position of the object, the GPS derived position, the velocity, the DOP (dilution of precision) and the continuity of satellites for which data is received, the system determines whether the GPS data is reliable. If the GPS data is reliable, the previous position of the object is updated to the GPS derived position. The updated position is then matched to roads in an electronic map. However, U.S. Pat. No. 5,948,043 did not teach adding a new path to a navigation plan either.

The inventor of the present invention perceives room for improvement in the navigation planning function of a conventional GPS navigation device and therefore proposes a navigation device capable of adding paths to a navigation plan independently.

### SUMMARY OF THE INVENTION

The objective of the present invention is to provide a navigation device capable of adding new paths conveniently and dynamically and enhancing the completeness of a navigation plan using the added paths.

To achieve the objective of the present invention, the present invention provides a navigation device capable of adding paths to a navigation plan independently. The navigation device comprises: a global positioning module for receiving road track coordinates signals of new paths to be created; a dynamic path-adding module for creating new path data corresponding to the new paths in accordance with the road track coordinates signals of the new paths, determining at least three added paths based on a map database and all linked paths linked to the new paths, and creating added path data corresponding to the added path; and a navigation module for planning at least a navigation route based on the map database, the new path data, and the added path data.

### BRIEF DESCRIPTION OF THE DRAWINGS

The structure and the technical means adopted by the present invention to achieve the above and other objectives can be best understood by referring to the following detailed description of the preferred embodiments and the accompanying drawings, wherein:

FIG. 1 is a schematic view showing architecture of a navigation device capable of adding new paths to a navigation plan independently according to the present invention;

FIG. 2 is a schematic view showing the screen of a dynamic path-adding module started to operate at the commencement of a drive on a road not yet recorded in a map database according to the present invention;

FIG. 3A is a schematic view of new paths dynamically created and added paths according to the present invention;

FIG. 3B is a schematic view of another embodiment of new paths dynamically created and added paths according to the present invention;

FIG. 4 is a schematic view of examples of all navigation routes likely to be planned by a navigation module of the navigation device according to the present invention; and

FIGS. 5A to 5C are schematic views of examples of the navigation routes determined by the navigation module of the navigation device according to the present invention.

### DETAILED DESCRIPTION OF THE INVENTION

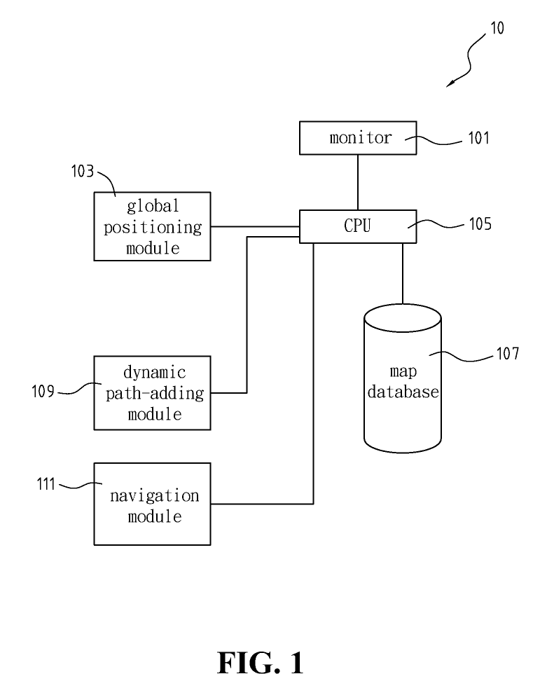

The present invention proposes a navigation device 10 capable of adding new paths to a navigation plan independently, as shown in FIG. 1. The navigation device 10 of the present invention may be installed in a vehicle, such as an automobile. Upon emergence of an automobile on a road, an electronic map of the road and neighboring roads is displayed on a monitor 101 of the navigation device 10; meanwhile, a global positioning module 103 of the navigation device 10 receives road track coordinates signals continuously, and a central processing unit (CPU) 105 of the navigation device 10 receives the road track coordinates signals, updates the electronic map in accordance with the received road track coordinates signals, and instructs the monitor 101 to display the updated electronic map. The navigation device 10 comprises a map database 107 that is built in. Normally, the map database 107 is stored in a flash memory or a memory card.

If an automobile travels on a road not yet recorded in the map database 107, for example, a newly paved road, the navigation device 10 cannot provide or display an electronic map pertaining to the newly paved road. It is because the map database 107 does not have any data about the newly paved road. In the above scenario—where an automobile travels on a road not yet recorded in the map database 107—a dynamic path-adding module 109 can make a difference. The dynamic path-adding module 109 is manually started to operate. Alternatively, the dynamic path-adding module 109 is automatically started by the navigation device 10 to operate, as determined by the navigation device 10 automatically. To start the dynamic path-adding module 109 manually, a user has to give a start instruction by pressing a related button on the panel of the navigation device 10. To start the dynamic path-adding module 109 automatically, the navigation device 10 has to detect an automobile traveling on a road not yet recorded in the map database 107 so as for the CPU 105 to instruct the dynamic path-adding module 109 to operate immediately.

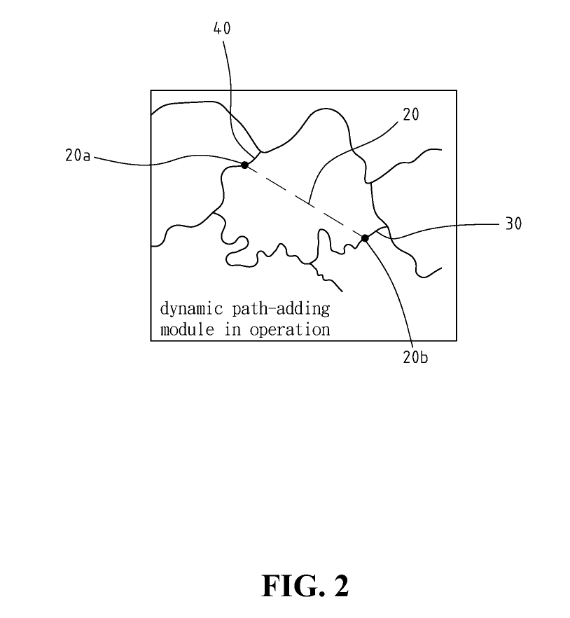

Referring to FIG. 2, the automobile reaches an origin 20a on a road 20 not yet recorded in the map database 107, and the road 20 is indicated by a dashed line. Note that map-related data pertaining to the road 20 are unavailable in the map database 107, and thus the monitor 101 does not display the road 20. However, to describe the present invention, a dashed line is employed to indicate the road 20. The global positioning module 103 receives coordinates signals pertaining to the origin 20a, and the dynamic path-adding module 109 records the coordinates signals pertaining to the origin 20a. Afterward, with the automobile traveling onward, the global positioning module 103 receives the road track coordinates signals pertaining to the road 20 continuously, and the dynamic path-adding module 109 records the road track coordinates signals. Upon the automobile's arrival at a destination 20b on the road 20, the global positioning module 103 receives coordinates signals pertaining to the destination 20b, and the dynamic path-adding module 109 records the coordinates signals pertaining to the destination 20b. Then, the automobile passes the destination 20b on the road 20 and goes to a road 30; meanwhile, map-related data about the road 30 have been stored in the map database 107, and thus an electronic map of the road 30 and neighboring roads is displayed on the monitor 101.

To shut down the dynamic path-adding module 109 manually, the user has to give a shutdown instruction by pressing a related button on the panel of the navigation device 10. To shut down the dynamic path-adding module 109 automatically, the navigation device 10 has to detect an automobile traveling on a road recorded in the map database 107 so as for the CPU 105 to instruct the dynamic path-adding module 109 to shut down immediately.

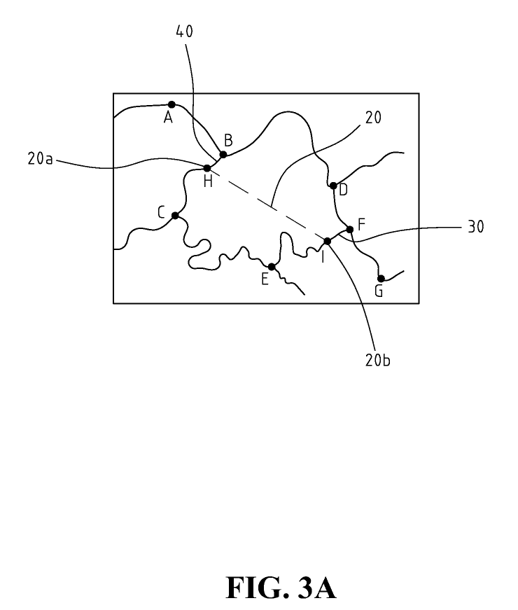

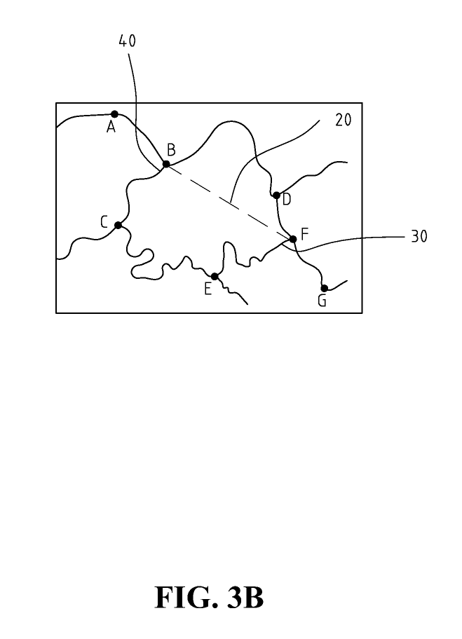

The present invention defines a portion of the road 20 from the origin 20a to the destination 20b as a new path, and if a road has two ends crossed by two other roads, respectively, the present invention defines the portion of the road as a path. Referring to FIG. 3A, a new path HI is linked to the roads 30 and 40 having their map-related data stored in the map database 107; in other words, the new path HI intersects the road 30 at the destination 20b, and intersects the road 40 at the origin 20a.

Linked to the new path HI, the road 40 is assigned a path BH and a path HC. Linked to the new path HI, the road 30 is assigned a path FI and a path IE. In the present invention, the paths BH, HC, FI, and IE are regarded as added paths.

The dynamic path-adding module 109 assigns linkage-related data to the new path HI. An identification code of the new path HI is directly generated by the dynamic path-adding module 109. The user enters the name and category (for example, general road, one-way road, and freeway) of the new path HI in response to a prompt provided by the dynamic path-adding module 109. The coordinates of the origin 20a and destination 20b of the new path HI are determined by the dynamic path-adding module 109 according to the corresponding road track coordinates signals. The length of the new path HI is calculated and set by the dynamic path-adding module 109 according to the road track coordinates signals pertaining to the road 20.

Furthermore, the dynamic path-adding module 109 accesses the map database 107 for map-related data pertaining to the roads 30 and 40, and processes the map-related data according to the road track coordinates signals pertaining to the road 20 so as to determine the linked paths. The dynamic path-adding module 109 determines that a path BC and a path FE are linked to the new path HI. The paths BC and FE account for a portion of linkage-related data about the new path HI. Then, the dynamic path-adding module 109 creates added paths according to the linked paths and the new paths. For instance, the dynamic path-adding module 109 creates the added paths BH, HC, FI, and IE according to data about intersection of the new path HI and the road 40 at the origin 20a, data about intersection of the new path HI and the road 30 at the destination 20b, and map-related data about the roads 30 and 40.

Also, the dynamic path-adding module 109 enables the user to manually enter data about at least a landmark (POI, point of interest) datum of the new path HI.

The dynamic path-adding module 109 adds data about the new path HI and data about the added paths BH, HC, FI, and IE to the map database 107. Alternatively, the data about the new path HI and the data about the added paths BH, HC, FI, and IE are stored in a storage device, such as a flash memory or a memory card, rather than added to the map database 107, by the dynamic path-adding module 109.

Referring to FIG. 3B, another said road 20 referred to as new path BF is created between an intersection B and an intersection F. The intersection B and the intersection F are shared among the new path BF and existing roads pertaining to original map-related data, and thus no added paths are shown in FIG. 3B.

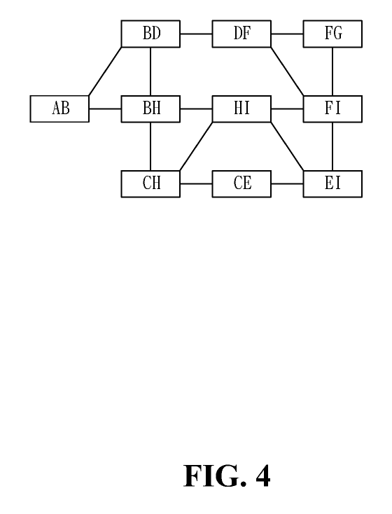

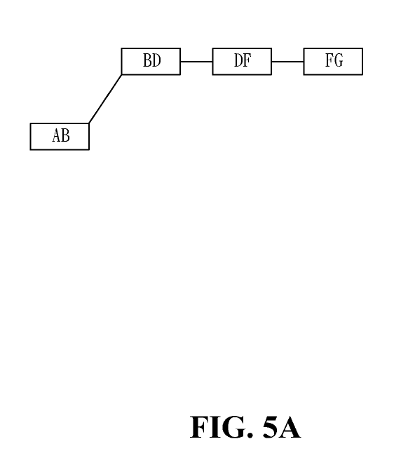

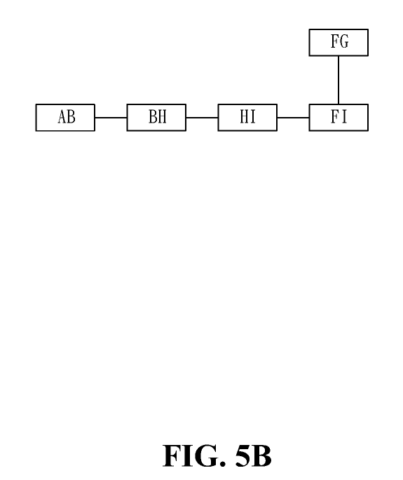

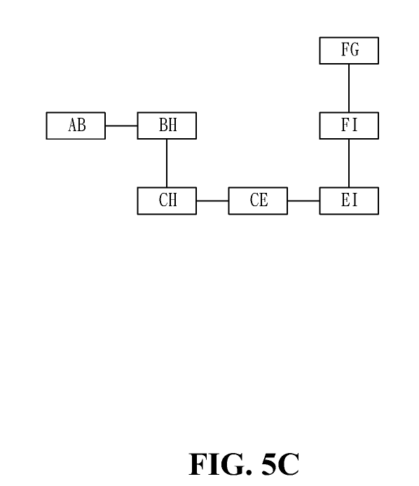

Referring to FIGS. 4, and 5A to 5C, after the user gives the instruction of a navigation plan to travel from an origin A to a destination G, the navigation module 111 performs navigation planning so as to plan at least a navigation route by reference to the map database 107, the data about the new path HI, and the added paths BH, HC, FI, and IE. Conventional navigation devices are not based on the technology of the dynamic path-adding module 109 disclosed in the present invention, and thus the conventional navigation devices can perform navigation planning on the seven paths only, namely the paths AB, BC, BD, CE, DF, EF, and FG. In the present invention, the navigation device 10 is based on the technology of the dynamic path-adding module 109, and thus the navigation device 10 can perform navigation planning on the ten paths, namely the paths AB, BD, CE, DF, FG, BH, CH, EI, FI, and HI, resulting in all navigation routes likely to be planned by the navigation device 10 as shown in FIG. 4. Finally, the navigation module 111 selects at least a navigation route from all the likely navigation routes as shown in FIGS. 5A to 5C and provides the at least a navigation route for the user to choose.

The merits of the present invention are that the navigation device of the present invention is based on the technology of the dynamic path-adding module and thereby is capable of adding paths conveniently and dynamically and thereby enhancing the completeness of a navigation plan.

The foregoing descriptions are only the preferred embodiments of the present invention and are not intended to restrict the scope of the present invention. It is apparent to those skilled in the art that all equivalent modifications and variations made in the foregoing embodiments should be considered as falling within the scope of the substantial content of the present invention.

What is claimed is:

1. A navigation device capable of adding paths to a navigation plan independently, comprising:
a global positioning module for receiving road track coordinates signals of new paths to be created;
a dynamic path-adding module for creating new path data corresponding to the new paths in accordance with the road track coordinates signals of the new paths, determining an added path based on a map database and all linked paths linked to the new paths, and creating added path data corresponding to the added path; and
a navigation module for planning at least a navigation route based on the map database, the new path data, and the added path data.

2. The navigation device capable of adding paths to a navigation plan independently of claim 1, wherein the new path data at least comprise coordinates of an origin, coordinates of a destination, a path length, a path name, and at least a linked path.

3. The navigation device capable of adding paths to a navigation plan independently of claim 2, wherein the new path data further comprise an identification code and a category.

4. The navigation device capable of adding paths to a navigation plan independently of claim 2, wherein the new path data further comprise at least a landmark datum.

5. The navigation device capable of adding paths to a navigation plan independently of claim 1, wherein the dynamic path-adding module is manually started to operate.

6. The navigation device capable of adding paths to a navigation plan independently of claim 1, wherein the dynamic path-adding module is automatically started by the navigation device to operate.

7. The navigation device capable of adding paths to a navigation plan independently of claim 1, wherein the dynamic path-adding module further adds the new path data and the added path data to the map database.

8. The navigation device capable of adding paths to a navigation plan independently of claim 1, wherein the dynamic path-adding module further stores the new path data and the added path data in a storage device.
